(19) United States
(12) Patent Application Publication
(10) Pub. No.: US 2019/0169797 A1
(43) Pub. Date: Jun. 6, 2019

(54) METHOD OF PRODUCING A CARBOXYALKYLATED NFC PRODUCT, A CARBOXYALKYLATED NFC PRODUCT AND USE THEREOF

(71) Applicant: RISE INNVENTIA AB, Stockholm (SE)

(72) Inventor: Ali NADERI, Vällingby (SE)

(21) Appl. No.: 16/316,758

(22) PCT Filed: Jun. 20, 2017
(86) PCT No.: PCT/SE2017/050673

§ 371 Date: Jan. 10, 2019

(30) Foreign Application Priority Data
Jul. 15, 2016 (SE) 1651068-7

(51) Int. Cl. D21H 11/18; C08B 11/12; C08L 1/28; D21C 9/00; D21H 21/06

(52) U.S. Cl. CPC D21H 11/18; C08B 11/12; C08L 1/286; D21H 21/06; D21C 9/007; D21C 9/004; D21C 9/005

(57) ABSTRACT

The present invention relates to a method of producing a nanofibrillated cellulose (NFC), the nanofibrillated cellulose product obtained and the use of the nanofibrillated cellulose product. The method comprises the steps of: Providing cellulosic fibres dispersed in water; Solvent-exchanging water in the fibres to an organic solvent, such as alcohol, suitably ethanol or isopropanol; Impregnating the fibres with a solution comprising a halogenated aliphatic acid having more than 2 carbon atoms; Heat-treating the impregnated fibres at a temperature of more than 50° C. in an alkaline solution comprising an organic solvent, which solution is optionally aqueous, to carboxyalkylatethe fibres; Washing the fibres; Converting the carboxyl groups their alkali metal counter-ion form; Optionally filtering the fibres; Dispersing the fibres in water; Mechanically disintegrating the fibres to provide the NFC product.

### TECHNICAL FIELD

The present invention relates to a method of producing a nanofibrillated cellulose (NFC) product, the nanofibrillated cellulose product obtained and the use of the nanofibrillated cellulose product.

### BACKGROUND ART

Nanofibrillated cellulose (NFC) is a material which is being employed in several applications. For example, NFC can be used in the pulp and paper industry to strengthen paper and cardboard products. It can also be applied in e.g. cosmetics as a rheological modifier and can be used as an odour-eliminating agent in diapers. However, a broader employment of NFC requires the overcoming of several challenges. For example, the production of transparent NFC-films and strong NFC-based filaments requires a low fibre fragment content in the employed NFC. In addition, several applications, e.g. coating of various substrates and production of NFC-based polymer composites, require concentrated or completely dried NFC, which can be diluted to a desired consistency. However, the concentrated NFC should be re-dispersible in an easy way when required. This means that the concentrated NFC has to have the ability to regain its original properties using industrially relevant and low cost processes, which constitutes a significant challenge. Many of the challenges can be overcome by the employment of highly charged NFC-grades, but this route is less attractive due to the increasing difficulty and thus cost for dewatering of the systems. Furthermore, there is an upper limit to the charge density that can be used, above which the integrity of the NFC deteriorates, which negatively affects several properties.

There have been attempts to improve re-dispersibility of NFC. For example Eyholzer et al. deal with the problem in a published article: “Preparation and characterization of water-redispersible nanofibrillated cellulose in powder form”, Cellulose (2010) 17:19-30. In the article, an improved water-re-dispersibility could be obtained when compared to an untreated bleached beech pulp. However, even though there are prior art attempts to improve the re-dispersibility of NFC, there is still a need to improve the methods to provide re-dispersible NFC-products.

### SUMMARY OF THE INVENTION

It is an object of the invention to provide a method for producing chemically modified nanofibrillated cellulose (NFC), which allows for the production of a charged NFC with a lower fibre fragment content, i.e. a higher degree of fibrillation, and significantly improved re-dispersion properties without having to increase the charge density of the system.

It is also an objective to provide a NFC product without having to increase the charge density beyond the currently employed amounts.

The objects above are attained by the method as defined in the appended claims.

The method of producing a nanofibrillated cellulose (NFC) product comprises steps of:
i. Providing cellulosic fibres dispersed in water;
ii. Solvent-exchanging water in the fibres to an organic solvent;
iii. Impregnating the fibres with a solution comprising a halogenated aliphatic acid having more than 2 carbon atoms;
iv. Heat-treating the impregnated fibres at a temperature of more than 50° C. in an alkaline solution comprising an organic solvent to carboxyalkylate the fibres;
v. Washing the fibres;
vi. Converting the carboxyl groups to their alkali metal counter-ion form;
vii. Optionally filtering the fibres;
viii. Dispersing the fibres in water;
ix. Mechanically disintegrating the fibres to provide an NFC product.

The halogenated aliphatic acid may be 2-chloropropionic acid (CPA). CPA provides sufficient reactivity for industrially feasible applications.

The alkaline solution in step iv) is obtained by the use of sodium hydroxide. Sodium hydroxide is commonly used in pulping and is readily available in the pulping industry.

The organic solvent in the alkaline solution in step iv) may comprise at least one of methanol, ethanol and isopropanol or any mixture thereof. A suitable amount of water may be used together with the organic solvent. Such alcohols provide suitable conditions for carboxyalkylation of the fibres.

The washing in step v) is suitably performed in three steps comprising at least one step of washing in water and at least one step of washing in a solution comprising an organic acid, suitably acetic acid. In this way, the fibres are prepared for conversion of the carboxyl groups to their alkali metal counter-ion form in the next step of the method.

Suitably, the alkali metal counter-ion form of the carboxyl group is comprised of sodium. Suitable fibres for further processing can thus be provided. Also, fibres swell more when the carboxyl group is in its alkali metal counter-ion form.

The total charge of the fibres and/or the NFC product is preferably from 600-700 μeq/g, determined by means of conductometric titration. Such charge-level provides a product that can be used for several different applications without affecting the fibre properties negatively. The degree of substitution (D.S.) of the fibres is from 0.1 to 0.3, preferably from 0.1 to 0.2, most preferably from about 0.1 to 0.15. When the CPA is used in the process, the necessary amount of charges that is required to achieve attractive properties, e.g. higher degree of fibrillation and better re-dispersion, are significantly lower compared to e.g. monochloroacetic acid (MCA) which is used in the prior art processes.

The fibres in the NFC product have suitably a fibre diameter of about 3 to 100 nm. The dry-content of the NFC-product obtained after mechanical disintegration in the step ix) is from 0.05 to 10% by weight, suitably from 0.1 to 6% by weight and preferably from 1-3% by weight. By having the dry-content within these ranges provides an industrially suitable product.

According to an embodiment, the method further comprises a step x) of drying the NFC-product to provide a concentrated or dried NFC-product. In this way the NFC can be transported in larger quantities at lower cost and lower negative impact on the environment.

When the NFC-product is dried or highly concentrated, it needs to be re-dispersed before use in the final application. Thus, method may further comprise a step xi) of re-dispersing the dried NFC-product in an aqueous solution.

The objects stated above are also obtained by an NFC-product obtained by the method as described above.

The obtained NFC-product may be used in cosmetic products, pharmaceutical products, food products, paper products, composite materials, coatings, hygiene/absorbent products, films, emulsion/dispersing agents, and drilling muds. The obtained NFC-product may also be used to enhance the reactivity of cellulose in the manufacture of regenerated cellulose or cellulose derivatives or in rheology modifiers.

Further features and advantages of the present invention are described in the following detailed description and examples.

### BRIEF DESCRIPTION OF THE DRAWINGS

FIG. 1 shows a flow chart illustrating the steps of the method according to the present disclosure,

FIG. 2 shows swelling of a dried NFC-product produced according to the present method; and

FIG. 3 shows swelling of a dried NFC-product produced according to a prior art method.

### DETAILED DESCRIPTION

Nanocellulose is a collective term used to describe the large category of nanocellulose products. Products encompassed by this term generally include nanofibrillated cellulose (NFC) also referred to as cellulose nanofibrils (CNF) and microfibrillated cellulose (MFC), nanocrystalline cellulose (NCC) which is also referred to as cellulose nanocrystals (CNC) or nanowhiskers and bacterial cellulose or bacterial nanocellulose. In this disclosure, the nanocellulose is cellulosic material that is produced through an at least partly mechanical nanofibrillation process, whereby the cellulosic material is disintegrated into a major fraction of individualized elementary nanofibrils and their aggregates. Nanofibrils have diameters of roughly 3-100 nm and can have lengths up to several micrometers. A nanocellulose product can be provided as a gel or dry matter. Nanocellulose can form gels at a concentration of below 1 wt % and at least within the concentration range of 0.1-10 wt %, calculated as dry matter and based on the total weight of the gel, depending on the degree of fibrillation and fibril length.

Included among the mechanical treatments that can be used to obtain nanocellulose are high-pressure homogenization, ultrasonic homogenization, supergrinding/refiner-type treatments, combinations of beating, rubbing, and homogenization, high-shear refining and cryocrushing in various configurations, microfluidization, extrusion and ball-milling.

Cellulosic fibres may be obtained from any cellulose containing source, but especially wood pulp. Suitable wood pulps include, but are not limited to, kraft, soda, sulfite, mechanical, a thermomechanical (TMP), a semi-chemical, or a chemi-thermomechanical (CTMP) pulp. A raw material for the pulps can be based on softwood, hardwood, recycled fibres or non-wood fibres. The softwood tree species can be for example, but are not limited to: spruce, pine, fir, larch, cedar, and hemlock. Examples of hardwood species from which pulp useful as a starting material in the present invention can be derived include, but are not limited to: birch, oak, poplar, beech, eucalyptus, acacia, maple, alder, aspen, gum trees and gmelina. The raw material may comprise a mixture of different softwoods, e.g. pine and spruce. The raw material may also comprise a non-wood raw material, such as bamboo, sugar beet pulp, wheat straw, soy hulls, bagasse, kelp and seaweeds, such as cladophora. The raw material may also be a mixture of at least two of softwood, hardwood and/or non-wood.

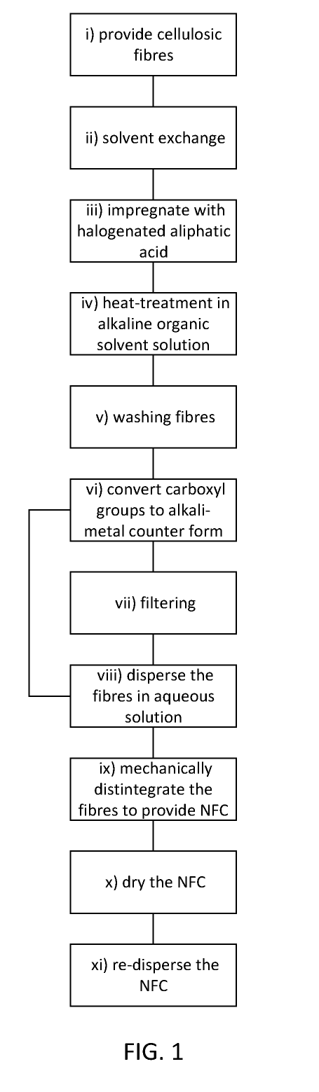

In accordance with the present invention, a method of producing a nanofibrillated (NFC) product is provided. The method is schematically illustrated in the appended FIG. 1. The method comprises in the first step i) providing cellulosic fibres dispersed in water. The fibres may be obtained from the sources mentioned above. The fibres are normally provided dispersed in water. The water dispersion may also include one or more additives. Since nanocellulose can be produced from various green resources, such as wood, agricultural residues and non-wood material, it is thus renewable and biodegradable.

Reference is now made to the appended drawings in which FIG. 1 shows a flow chart of the steps of the method according to the present disclosure. In the step ii) water in the fibres is solvent-exchanged to an organic solvent. The solvent is preferably alcohol-based C1-C6 alcohol, for example methanol, ethanol, isopropanol or tert-butanol or the solvent may be any other corresponding solvent, such as acetone or any mixtures thereof. Solvent exchange is performed to remove water from the fibres.

In the step iii) the fibres are impregnated with a solution comprising a halogenated aliphatic acid having more than 2 carbon atoms. When the amount of carbon atoms is more than 2, it is assumed without binding to any theory, that the distance between the fibres can be increased. The halogen atom can be e.g. Br, I or Cl, and is preferably Cl, which provides sufficient reactivity in industrially relevant conditions and is commonly used in industrial applications. Preferably the amount of carbon atoms is 3, and the halogenated aliphatic acid is 2-chloropropionic acid (CPA) or an acid salt thereof. The amount of the used halogenated aliphatic acid is dependent on the raw material, i.e. for example the pulp from which the cellulosic fibres are derived, the solvent combinations and the desired degree of substitution, which desirably is between 0.1-0.3. It is clear for the skilled person how to adjust the amount of the halogenated aliphatic acid so that the desired degree of substitution is obtained. The amount can vary greatly and can be, but is not limited to, from 0.1-2 g halogenated aliphatic acid /g fibre , e.g. 0.1-2 g CPA/g fibre.

In the step iv) the impregnated fibres are heat-treated at a temperature of more than 50° C. in an alkaline solution comprising an organic solvent. The alkaline solution can be aqueous. In this step, the fibres are carboxyalkylated, i.e. the fibres are modified by carboxyalkyl groups, i.e. carboxyalkyl groups are incorporated to the fibres. When the halogenated aliphatic acid is 2-chloropropionic acid, —CH(CH₃)—COOH groups are incorporated into the fibres. In the disclosed prior art in the background, the halogenated aliphatic acid is monochloroacetic acid (MCA), whereby the fibres are carboxymethylated, i.e.

—CH₂—COOH group or groups are incorporated to the fibres.

The alkaline conditions can be obtained by the use of sodium hydroxide, but any other alkali metal hydroxide could be used, such as KOH, CsOH, LiOH. The concentration of the alkali metal hydroxide in the solution can vary, but is normally at least 0.1 wt % to about 10 wt %, suitably from 0.1 to 5 wt %, preferably from 0.5 wt % to about 2 wt %, based on the weight of the total alkaline solution comprising the organic solvent.

The organic solvent suitably comprises or consists of an alcohol, such as C1-C6 alcohol, i.e. alcohol containing from 1 to 6 carbon atoms or a mixture thereof. The organic solvent can also contain water. The proportion of the organic solvent is dependent on the amount fibres to be modified. Preferably, the organic solvent comprises or consists of methanol, ethanol and isopropanol or any mixture thereof, optionally with some water added. However, also for example tert-butanol could be conceivable. The temperature for the heat-treatment is suitably adjusted so that it is just below the boiling point of the organic solvent and at least 50° C. The temperature is defined by the boiling temperatures of the organic solvents.

In the carboxyalkylated fibres, hydrogen atoms of the hydroxyl groups are thus substituted by charged carboxyalkyl groups. The total charge of the fibres can be determined by means of conductometric titration. The total charge can then be used to calculate degree of substitution.

By “degree of substitution” or “DS”, is meant that the average number of charged groups per glucose unit. The total charge of the fibres and/or the NFC product can be in the range from 600-700 μeq/g, determined by means of conductometric titration (see Katz et al.). The degree of substitution of the fibres in the present disclosure can be from about 0.1 to 0.3.

The method further comprises washing of the fibres in the step v). The washing step is performed in order to remove excess reagents. Thus, in the washing step, excess alkali, e.g. sodium hydroxide, and excess organic solvent from the previous step are removed. Washing is suitably performed in two or more steps, preferably in three steps. The steps comprise at least one step of washing in water and at least one step of washing in a solution comprising an organic acid, suitably acetic acid. The pH of the fibre dispersion is suitably kept at about 2 during washing with the organic acid. Suitably, the fibres are first washed with water, which is preferably de-ionized. Thereafter the fibres are washed with organic acid, and the pH of the fibres dispersion is suitably kept at about 2. Finally, the fibres are washed once more with water.

In the next step vi) the carboxyl groups are converted to their alkali metal counter-ion form. The counter-ion should be a monovalent cation, such as an alkali metal ion, e.g. Li⁺, Na⁺, K⁺ or Cs⁺. Preferably, the alkali metal counter-ion form of the carboxyl group is in its sodium-form. When the carboxyl groups are in their monovalent counter-ion form, there is less inter-action with carboxylate groups. Therefore, it is possible to obtain higher degree of swelling whereby it is for example easy to delaminate the fibres.

In the step vii) the fibres may be filtered to remove washing liquids from the fibre dispersion, but the filtering step is optional and may be omitted in some embodiments.

In the step viii) the fibres are dispersed in water so that the mechanical disintegration step ix) can be performed in a convenient way. The mechanical disintegration provides fibres in the NFC product which have a fibre diameter of about 3 to 100 nm, i.e. nanofibrillated cellulose. After the step ix) the dry-content of the NFC-product obtained in step ix) is from 0.05 to 10% by weight, suitably from 0.1 to 6% by weight and preferably from 1-3% by weight. The obtained NFC product may then be dried in the step x) to provide a concentrated or dried NFC-product. The concentrated or dried product can then be re-dispersed when desired in an aqueous solution in the step xi). The re-disperability and the properties of the re-dispersed NFC-product are essentially improved by the use of CPA according to the present invention in carboxyalkylation of the fibres.

It should be noted that the order of the steps may be altered, if applicable. Also the steps may be performed simultaneously or separately.

The present invention also relates to the NFC-product obtained by the method as described above and to the use of the product in cosmetic products, pharmaceutical products, food products, paper products, composite materials, coatings, hygiene/absorbent products, films, emulsion/dispersing agents, drilling muds and to enhance the reactivity of cellulose in the manufacture of regenerated cellulose or cellulose derivatives or in rheology modifiers.

Without wishing to be bound by theory, it is believed that the present inventive method disrupts the cooperative hydrogen bonding more effectively, which is the assumed mechanism behind hornification, by using the charged groups which have a larger size than currently used equivalents, e.g. the used CPA has a larger size than MCA. It is also believed that CPA can penetrate the fibrous system more effectively than what can be obtained by MCA. Further, CPA displays sufficient reactivity to be attached to the fibrous material, under industrially relevant conditions.

### EXAMPLES

Samples of nanofibrillated cellulose (NFC) modified using monochloroacetic acid (MCA, comparative example) and 2-chloropropanoic acid (CPA) were prepared by the method described below. The samples were then dried and redispersed in water by the method described below. Various properties of the never-dried NFCs (termed N.d.) and redispersed NFCs (termed Redisp.) were then determined by the methods described below.

Preparation of Samples and Test Methods

Carboxyalkylated Nanofibrillated Cellulose

A commercial never-dried TCF-bleached sulphite dissolving pulp (trade name: Dissolving Plus) from a mixture of Norway spruce (60%) and Scottish pine (40%) was obtained from Domsjö Fabriker (Domsjö Mill, Sweden). Never-dried fibres were dispersed in water at 10000 revolutions using an ordinary laboratory blender. This was conducted in smaller batches of 30 grams of fibres in two liters of water. The fibres were then solvent-exchanged to ethanol by washing the fibres in one liter of ethanol four times with a filtering step in between.

The fibres (110 grams) were then impregnated for 30 minutes with a solution of of monochloroacetic acid (MCA) or 2-chloropropionic acid (CPA) in 500 ml of isopropanol. Subsequently, the fibres were added in portions to a solution of NaOH in 500 ml methanol and mixed with two liters of isopropanol that had been heated just below its boiling temperature in a five-liter reaction vessel fitted with a condenser.

Following the carboxyalkylation step, the fibres were filtered and washed in three steps. First, the fibres were washed with 20 liters of deionized water. Thereafter, the fibres were washed with two liters of acetic acid (0.1 M) and finally with 10 liters of water. The fibres were then impregnated with two liters NaHCO₃ solution (4% w/w solution) for 60 minutes in order to convert the carboxyl groups to their sodium form. Then, the fibres were washed with 15 liters of water and drained on a Büchner funnel.

The total charge of the pulp (and hence the resulting NFC), in its sodium counter-ion form, was determined by means of conductometric titration to be ca 640 μeq/g (degree of substitution (D.S.)≈0.11). The method is described in “Katz, S.; Beatson, R. P.; Scallan, A. M., The determination of strong and weak acidic groups in sulfite pulps. Sven. Papperstidn. 1984, 87, R48-R53”.

TABLE 1
The conditions that were used to carboxyalkylate
pulp (Pulp) with different reagents: mono-chloroacetic
acid (MCA) and 2-chloropropionic acid (CPA).

| | Pulp_{MCA} | Pulp_{CPA} |
|---|---|---|
| Pulp (g) | 30 | 30 |
| MCA (g) | 2.9 | 0 |
| CPA (g) | 0 | 27.3 |
| NaOH (g) | 4.4 | 14.1 |
| 2-propanol (g) | 535 | 501 |
| Ethanol (g) | 120 | 120 |
| Methanol (g) | 108 | 108 |
| Heating time (h) | 1 | 3 |

Production of NFC Products

The carboxyalkylated pulps were dispersed in water (to a consistency of 2% (w/w)) by a propeller mixer for one hour. The suspensions were thereafter microfluidized (Microfluidizer M-110EH, Microfluidics Corp., USA) by passing the slurries one time at 1700 bar through two Z-shaped chambers with diameters of 200 μm and 100 μm, respectively. The products were thereafter kept in a fridge (at 5° C.), until further investigations.

Protocol for Drying of NFC and its Subsequent Re-Dispersion

Nanofibrillated cellulose suspensions (2% (w/w), 300 grams) were poured into 2 litre petri dishes, and were dried in an oven at 105° C. Thereafter, the dried materials were torn into pieces and were equilibrated overnight in deionized water, at a total dry content of 2% (w/w). The suspensions were thereafter mixed with a propeller mixer Oka Eurostar basic, Germany, 2000 rpm/2 minutes), and then homogenized (at 20000 rpm for 30 seconds) using a rotor-stator homogenizer (Kinematica polytron homogenizer PT-3100D, Switzerland).

Preparation of NFC-Films

Samples with dry contents of about 0.1% (w/w) were prepared by blending (using a magnetic stirrer for about 18 hours at 750 rpm) appropriate amounts of the concentrated materials with water. The obtained suspensions were thereafter degassed for one hour. Films were prepared first by vacuum filtration of the suspension using 0.65 p.m DVPP filters (supplied by Millipore), followed by drying in constrained form, in an oven for seven hours at 50° C.

Tensile Strength Measurements on NFC-Films

An MTS tensile strength machine with a Teststar IIS controller (MTS, USA) was used in the investigations. The NFC-film samples were kept at 50% RH/23° C., for at least three days, before conducting the measurements. The samples were weighted after strips were cut out. The length and width of the strips were 45 mm and 6 mm, respectively; the distance between the grips holding the strips was 30 mm. The strips were then mounted into a tensile strength machine and the mechanical properties were measured with a speed of 100%/min.

Rheological Studies

The rheological studies were conducted on samples that had been stored in a fridge (5° C.) for at least three days after their manufacturing, and then equilibrated overnight at room temperature.

The investigations were performed using a Kinexus stress controlled rotational rheometer (Malvern Instruments, UK) together with the software rSpace (Malvern Instruments, UK). A standard (ISO 3219/DIN 53019) metal concentric cylinder (bob and cup) geometry with serrated surfaces was used in the studies. The height and distance between the serrations were 300 μm and 1000 μm, respectively. The diameter and length of the bob were 25 and 37.5 mm, respectively; the diameter and wall height of the cup were 27.5 and 62.5 mm, respectively. A working gap of 9.15 mm was employed in the measurements. The set experimental temperature was 25° C.

The NFC samples were sheared at 100 s⁻¹ for one minute in the measuring chamber, as a mean to even out the heterogeneities, and then were left to equilibrate for two minutes before conducting the studies. The controlled shear rate measurements were conducted in the range of \dot{γ}=0.1-1000 s⁻¹. Integration time per measuring point was set to 30 seconds.

The viscosity of the different samples measured at the shear rate of 1 s⁻¹ have been displayed in Table 2 for comparison purposes.

Determination of the Apparent Efficiency of the Delamination Process

Nanofibrillated cellulose samples with a consistency of about 0.02% (w/w) were prepared by first blending the concentrated NFC systems with water (using a magnetic stirrer for about 18 hours at 750 rpm). The diluted systems were then centrifuged at 1000 g for 15 minutes, to remove the larger constituents (e.g. residual fibre-fragments).

The suspension concentrations before (c_{bc}) and after (c_{ac}) the centrifugation treatment were used to estimate the fraction of nano-sized cellulosic materials (c_{NS} % (w/w)) in the dry content of the suspension:

$${c}_{NS} \% ( w \text{/} w ) = \frac{{c}_{a c}}{{c}_{bc }} \times 100 \qquad ( 1 )$$

It is further noted that this method of analysis is based on the assumption that the magnitude of c_{NS} increases with the increasing efficiency of the delamination process.

Oxygen Permeability Measurements

The oxygen transmission rate (OTR) was monitored with a Mocon Ox-Tran model 2/20 MH System equipped with a coulometric oxygen sensor (Mocon, Minneapolis, USA). The NFC films were mounted in an isolated diffusion cell, where one side of the films is exposed to oxygen (99.95%) at atmospheric pressure. The oxygen, which permeates through the sample, is transported to a coulometric sensor, where the amount of oxygen is measured. The OTR was normalized with respect to the average thickness of the films (measured by scanning electron microscopy) to yield an oxygen permeability value, OP. The measurements were conducted at 23° C. and 50% RH.

Swelling

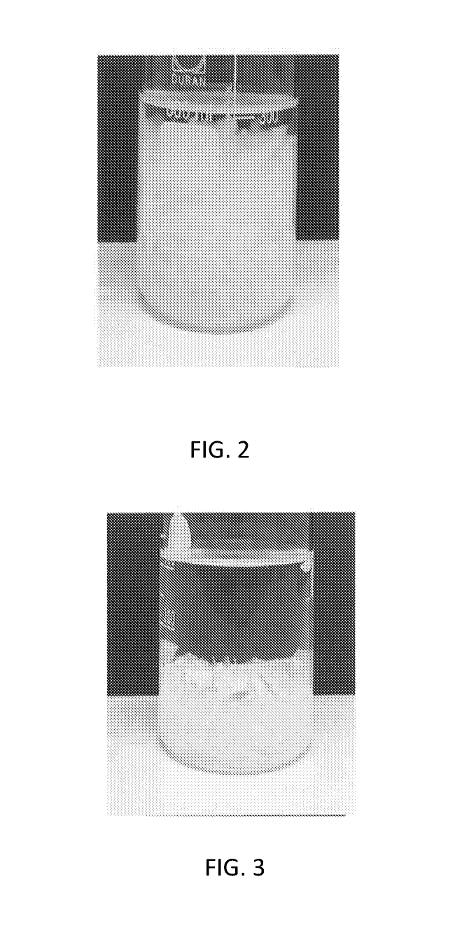

The swelling of dried NFCs based on different charged groups are shown in FIGS. 2 and 3. A notable spontaneous swelling is observed for the system based on 2-chloropropionic acid (CPA) after a few minutes. The swelled NFC treated with CPA is shown in FIG. 2. It is noted that the swelling starts to occur within minutes after immersion in water. The sample shown in FIG. 3, which was treated with mono-chloroacetic acid (MCA), swelled significantly less than the sample treated with CPA.

Results

The tensile strength index (TSI) of NFC-sheets, fraction of nano-sized materials (c_{NS}), OP (oxygen permeability) and viscosity measured at a shear rate of 1 s⁻¹ are shown in Table 2 below. N.d. denotes the properties of NFC in never-dried form. Redisp. denotes the properties of NFC after drying and redispersion.

TABLE 2

| | TSI_{Redisp} | C_{NS-Redisp} | OP_{Redisp} | Viscosity_{Redisp.} |
|---|---|---|---|---|
| | TSI_{N.d.} | C_{NS-N.d.} | OP_{N.d.} | Viscosity_{N.d.} |
| MCA | 0.77 ± 0.1 | 0.25 ± 0.01 | 3.0 ± 0.5* | 0.1 |
| CPA | 0.90 ± 0.08 | 0.72 ± 0.02 | 0.6 ± 0.1 | 0.9 |

*Increasing OP-ratio = diminishing barrier properties after redispersion

Conclusions

As it can be seen in Table 2, the properties of CPA-based system after redispersion (Redisp.) are closer to the properties of the never-dried (N.d.) equivalent as compared to the MCA-based NFC. For example, 90% of the tensile strength index (TSI), 72% of the fraction of nano-sized material (C_{NS}), 60% of the barrier property (OP) and 90% of the viscosity properties are obtained when CPA is used; lower and/or inferior values are observed when MCA is employed.

1. A method of producing a nanofibrillated cellulose (NFC) product comprising the steps of:
i) Providing cellulosic fibres dispersed in water;
ii) Solvent-exchanging water in the fibres to an organic solvent;
iii) Impregnating the fibres with a solution comprising a halogenated aliphatic acid having more than 2 carbon atoms;
iv) Heat-treating the impregnated fibres at a temperature of more than 50° C. in an alkaline solution comprising an organic solvent to carboxyalkylate the fibres;
v) Washing the fibres;
vi) Converting the carboxyl groups to their alkali metal counter-ion form;
vii) Optionally filtering the fibres;
viii) Dispersing the fibres in water; and
ix) Mechanically disintegrating the fibres to provide the NFC product.

2. The method according to claim 1, wherein the halogenated aliphatic acid is 2-chloropropionic acid.

3. The method according to claim 1, wherein the alkaline solution in step iv) is obtained by the use of sodium hydroxide.

4. The method according to claim 1, wherein the organic solvent in the alkaline solution in step iv) comprises at least one of methanol, ethanol and isopropanol or any mixture thereof.

5. The method according to claim 1, wherein the washing in step v) is performed in three steps comprising at least one step of washing in water and at least one step of washing in a solution comprising an organic acid.

6. The method according to claim 1, wherein the alkali metal counter-ion form of the carboxyl group comprises sodium.

7. The method according to claim 6, wherein the total charge of the fibres and/or the NFC product is from 600-700 μeq/g, determined by means of conductometric titration.

8. The method according to claim 6, wherein the degree of substitution of the fibres is from 0.1 to 0.3.

9. The method according to claim 1, wherein after the step ix), fibres in the NFC product have a fibre diameter of about 3 to 100 nm.

10. The method according to claim 1, wherein after the step ix) the dry-content of the NFC-product obtained in step ix) is from 0.05 to 10% by weight.

11. The method according to claim 1, wherein the method further comprises:
x) Drying the NFC-product to provide a concentrated or dried NFC-product.

12. The method according to claim 11, wherein the method further comprises:
xi) Re-dispersing the dried NFC-product in an aqueous solution.

13. An NFC-product obtained by the method according to claim 1.

14. A product comprising the NFC-product according to claim 13, wherein the product comprises a cosmetic product, a pharmaceutical product, a food product, a paper product, a composite material, a coating, a hygiene/absorbent product, a film, an emulsion/dispersing agent, or a drilling mud.

15. A composition for enhancing reactivity of cellulose in the manufacture of regenerated cellulose or a cellulose derivative, the composition comprising the NFC-product according to claim 13 and one or more of regenerated cellulose or a cellulose derivative.

16. A composition comprising the NFC-product according to claim 13 and a rheology modifier.
